(19) United States
(12) Patent Application Publication
(10) Pub. No.: US 2009/0257642 A1
(43) Pub. Date: Oct. 15, 2009

(54) Coin authenticity judging method and device

(75) Inventor: Kunihiro Sugita, Chuo-ku (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 12/221,881

(22) Filed: Aug. 7, 2008

Related U.S. Application Data
(63) Continuation of application No. 12/082,553, filed on Apr. 11, 2008.

(51) Int. Cl. G06K 9/00

(52) U.S. Cl. 382/136

(57) ABSTRACT

With a coin authenticity judging method according to an embodiment of the present invention, image data of an incuse/relief portion 14, formed on a surface of a medal 13, are acquired by capturing an image of the incuse/relief portion 14 by means of an image sensor 23, disposed so as to oppose the medal 13 substantially straightly, while illuminating light from a light source disposed obliquely above the medal 13, and an image processing of using two or more predetermined threshold values to multinarize brightness information, including shading related to the incuse/relief portion 14, in the acquired image data into three or more values is performed. By the image processing of multinarization into the three or more values, the medal 13 surface is regionally divided in to at least a profile region 14-1, a top surface region 14-2a, and a bottom surface region 14-2b in the incuse/relief portion 14. The authenticity of the medal 13 is then judged based on shape data of the incuse/relief portion 14 obtained by the image processing and master data, including a shape of an incuse/relief portion 14 formed on a surface of an authentic medal 13.

### FIELD OF THE ART

The present invention relates to a coin authenticity judging method and device for judging authenticity of coins, including medals for game machines, currency, etc.

### BACKGROUND ART

Conventionally, there is known an art, with which, in order to judge authenticity of a coin, such as a medal for a game machine, a currency, etc., a light source and an imaging device are disposed above the coin, image data of a surface of the coin are obtained by capturing an image of reflected light from the coin by the imaging device, and the image data are compared with image data of an authentic coin (see, for example, Japanese Published Unexamined Patent Application No. 1995-210720).

However, because a surface of a coin generally has luster, when, for example, the light source and the imaging device are positioned at a close distance, light emitted from the light source undergoes irregular reflection at the surface of the coin and clear image data cannot be obtained. In this case, there was a possibility of impairment of precision of authenticity judgment as a result of performing the authenticity judgment of the coin based on unclear image data.

### SUMMARY OF THE INVENTION

The present invention has been made to resolve the above issue of the conventional art and an object thereof is to contribute to improvement of authenticity judgment of coins.

To achieve the above object, a coin authenticity judging method according to the present invention includes the steps of: acquiring image data of an incuse/relief portion, formed on a surface of a coin, by illuminating light from a light source, disposed obliquely above the coin, and meanwhile capturing an image of the incuse/relief portion by an imaging unit, disposed so as to oppose the coin substantially straightly; performing an image processing of using predetermined threshold values to multinarize brightness information, including shading related to the incuse/relief portion, in the acquired image data; and judging authenticity of the coin based on shape data of the incuse/relief portion, obtained by the image processing, and master data, including a shape of an incuse/relief portion formed on a surface of an authentic coin; and is most principally characterized in that as the predetermined threshold values, two or more threshold values are set in consideration that the surface of the coin can be regionally divided at least into a profile region, a top surface region, and a bottom surface region in the incuse/relief portion, the multinarization is performed by quantizing the brightness information, including the shading related to the incuse/relief portion, into three or more values using the two or more threshold values, and the surface of the coin is regionally divided into at least the three regions by the image processing of multinarization into the three or more values.

An arrangement may also be employed where the image data of the incuse/relief portion are acquired by illuminating a plurality of lights, with mutually different wavelengths, from a plurality of light sources, disposed obliquely above the coin, and meanwhile capturing the image of the incuse/relief portion by the imaging unit through an optical filter that separates reflected light from the incuse/relief portion according to respective wavelengths, and the authenticity of the coin is judged by collecting and synthesizing, from among the image data of the respective wavelengths that have been subject to the multinarization image processing, a set of data belonging to a predetermined brightness and determining, based on shape data of the incuse/relief portion, obtained by the synthesis, and the master data, a correlation between the shape data and the master data.

In this process, the predetermined brightness is preferably both or either of a set of brightest data and a set of darkest data among the image data of the respective wavelengths that have been subject to the multinarization image processing.

An arrangement may also be employed where the plurality of light sources are three light sources, with mutually different wavelengths, and these light sources are positioned apart from each other across a substantially equal interval.

Furthermore, an arrangement may be employed where the three light sources have wavelengths of a substantially red color, a substantially green color, and a substantially blue color, and the optical filter separates lights having wavelengths of a substantially red color, a substantially green color, and a substantially blue color.

A coin authenticity judging device according to the present invention includes: a light source, disposed obliquely above a coin and illuminating light toward the coin; an imaging unit, disposed so as to oppose the coin substantially straightly and capturing an image and thereby acquiring image data of an incuse/relief portion formed on a surface of the coin; a master data storage unit, storing master data, including a shape of an incuse/relief portion formed on a surface of an authentic coin; an image processing unit, performing an image processing of using predetermined threshold values to multinarize brightness information, including shading related to the incuse/relief portion, in the image data acquired by the imaging unit; and an authenticity judging unit, judging authenticity of the coin based on shape data of the incuse/relief portion, obtained by the image processing unit, and the master data, stored in the master data storage unit; and here, an arrangement can be employed where as the predetermined threshold values, two or more threshold values are set in consideration that the surface of the coin can be regionally divided at least into a profile region, a top surface region, and a bottom surface region in the incuse/relief portion, the multinarization is performed by quantizing the brightness information, including the shading related to the incuse/relief portion, into three or more values using the two or more threshold values, and the image processing unit regionally divides the surface of the coin into at least the three regions by the image processing of multinarization into the three or more values.

An arrangement may also be employed where the light source is a plurality of light sources, illuminating a plurality of lights, with mutually different wavelengths, onto the coin, the imaging unit captures the image of and thereby acquires the incuse/relief portion through an optical filter that separates reflected light from the incuse/relief portion according to respective wavelengths, the image processing unit has a function of collecting and synthesizing, from among the image data of the respective wavelengths that have been subject to the multinarization image processing, a set of data belonging to a predetermined brightness and furthermore has a correlation computing unit, determining, based on shape data of the incuse/relief portion, obtained by the synthesis, and the master data, a correlation between the shape data and the master data, and the authenticity judging unit judges the authenticity of the coin based on a computation result of the correlation computing unit.

Here, the predetermined brightness is both or either of a set of brightest data and a set of darkest data among the image data of the respective wavelengths that have been subject to the multinarization image processing.

An arrangement may also be employed where the plurality of light sources are three light sources, with mutually different wavelengths, and these light sources are positioned apart from each other across a substantially equal interval.

Furthermore, an arrangement may be employed where the three light sources have wavelengths of a substantially red color, a substantially green color, and a substantially blue color, and the optical filter separates lights having wavelengths of a substantially red color, a substantially green color, and a substantially blue color.

### ACTIONS AND EFFECTS OF THE INVENTION

With the coin authenticity judging method according to the present invention, the image data of the incuse/relief portion formed on the surface of the coin is acquired by illuminating the light from the light source, disposed obliquely above the coin, and meanwhile capturing the image of the incuse/relief portion by the imaging unit, disposed so as to oppose the coin substantially straightly, and an image processing, of using the predetermined threshold values to multinarize the brightness information, including the shading related to the incuse/relief portion, in the acquired image data, is performed. In the image processing, the two or more threshold values, set as the predetermined threshold values in consideration that the surface of the coin can be regionally divided at least into the profile region, the top surface region, and the bottom surface region in the incuse/relief portion, are employed, the multinarization is performed by quantizing the brightness information, including the shading related to the incuse/relief portion, into three or more values using the two or more threshold values, and the surface of the coin is regionally divided into at least the three regions by the image processing of multinarization into the three or more values. The authenticity of the coin is then judged based on the shape data of the incuse/relief portion, obtained by the image processing, and the master data, including the shape of the incuse/relief portion formed on the surface of the authentic coin. Thus as a result of enabling the authenticity of the coin to be judged based on the shape data of the incuse/relief portion, identified at high precision by the surface of the coin being regionally divided into the at least three regions, the coin authenticity judgment can be improved significantly in precision.

Meanwhile, with the coin authenticity judging device according to the present invention, when light from the light source, disposed obliquely above the coin, is illuminated, the imaging unit, disposed so as to oppose the coin substantially straightly, acquires the image data of the incuse/relief portion formed on the surface of the coin. Subsequently, the image processing unit performs the image processing of using the predetermined threshold values to multinarize the brightness information, including the shading related to the incuse/relief portion, in the image data acquired by the imaging unit. In the image processing, the two or more threshold values, set as the predetermined threshold values in consideration that the surface of the coin can be regionally divided at least into the profile region, the top surface region, and the bottom surface region in the incuse/relief portion, are employed, the multinarization is performed by quantizing the brightness information, including the shading related to the incuse/relief portion, into three or more values using the two or more threshold values, and the surface of the coin is regionally divided into at least the three regions by the image processing of multinarization into the three or more values. The authenticity judging unit then judges the authenticity of the coin based on the shape data of the incuse/relief portion, obtained by the image processing unit, and the master data, stored in the master data storage unit. Thus as a result of enabling the authenticity of the coin to be judged based on the shape data of the incuse/relief portion, identified at high precision by the surface of the coin being regionally divided into at least the profile region, the top surface region, and the bottom surface region in the incuse/relief portion, the coin authenticity judging device, with which the precision of coin authenticity judgment can be improved significantly, can be obtained.

### BRIEF DESCRIPTION OF THE DRAWINGS

FIG. 1 is a block diagram of a coin authenticity judging device according to an embodiment of the present invention.

FIGS. 2A, 2B, and 2C are explanatory diagrams of brightness information, resulting from illumination of light from LEDs of the three colors of R, G, and B (substantially red, substantially green, and substantially blue) and including shading related to an incuse/relief portion on a coin surface.

FIG. 3 is an explanatory diagram of basic principles of a coin authenticity judging method according to an embodiment of the present invention.

FIG. 4 is an explanatory diagram of shape data of a medal resulting from collecting and synthesizing a set of brightest data among image data of respective wavelengths that have been subject to a multinarization image processing.

FIG. 5 is an explanatory diagram of shape data of the medal resulting from collecting and synthesizing a set of darkest data among the image data of the respective wavelengths that have been subject to the multinarization image processing.

FIG. 6 is an operation flowchart of the coin authenticity judging device according to the embodiment of the present invention.

### DETAILED DESCRIPTION OF THE INVENTION

A coin authenticity judging method according to an embodiment of the present invention and a preferred embodiment of a coin authenticity judging device shall now be described in detail with reference to the drawings.

The coin authenticity judging device according to the present invention can be applied to applications of judging authenticity of coins including medals or coins for game machines, currency, etc. With the present embodiment an example of application of the present invention to authenticity judgment of a medal used as a game medium in a game center or other amusement facility shall be described.

### General Arrangement of the Coin Authenticity Judging Device According to the Embodiment of the Present Invention

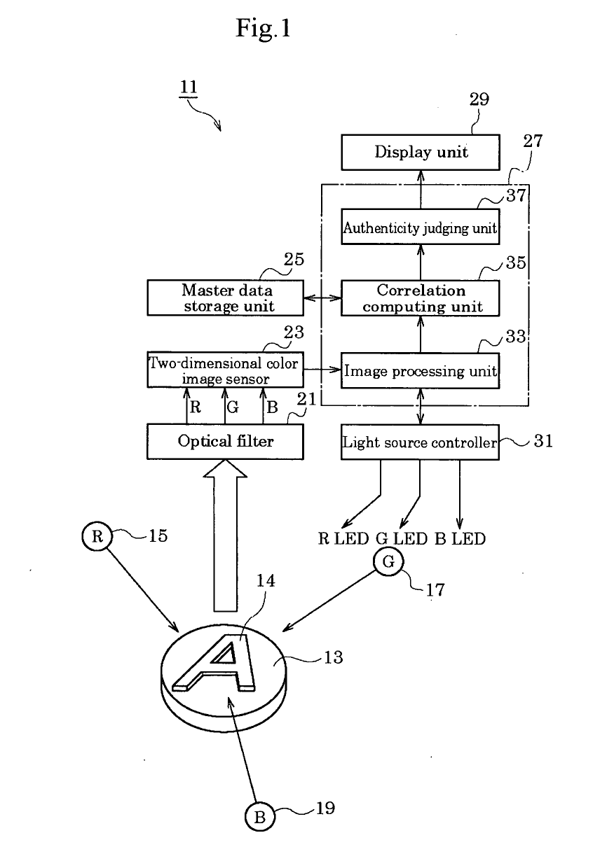

As shown in FIG. 1, a coin authenticity judging device 11 includes: a plurality of light sources 15, 17, and 19, illuminating a plurality of lights, having mutually different wavelengths, from obliquely above a surface of a medal (corresponding to being a “coin” in the present invention) 13; an optical filter 21, separating reflected light from the medal 13 surface according to respective wavelengths; a two-dimensional color image sensor (corresponding to being an “imaging unit” in the present invention) 23, taking in, via the optical filter 21, image data including an incuse/relief portion 14, formed three-dimensionally on the medal 13 surface, and outputting the image data; a master data storage unit 25, storing image data (hereinafter referred to as “master data”), including an incuse/relief portion 14 formed on a surface of an authentic medal; an authenticity judging unit 27, extracting, on basis of the image data output from the two-dimensional color image sensor (abbreviated hereinafter as “image sensor”) 23, information expressing a shape of the incuse/relief portion 14 formed on the medal 13 surface and judging authenticity of the medal 13 based on the extracted information expressing the shape of the incuse/relief portion 14 and the master data stored in the master data storage unit 25; a display unit 29, displaying an authenticity judgment result; and a light source controller 31, controlling timings of turning on/off the plurality of light sources 15, 17, and 19.

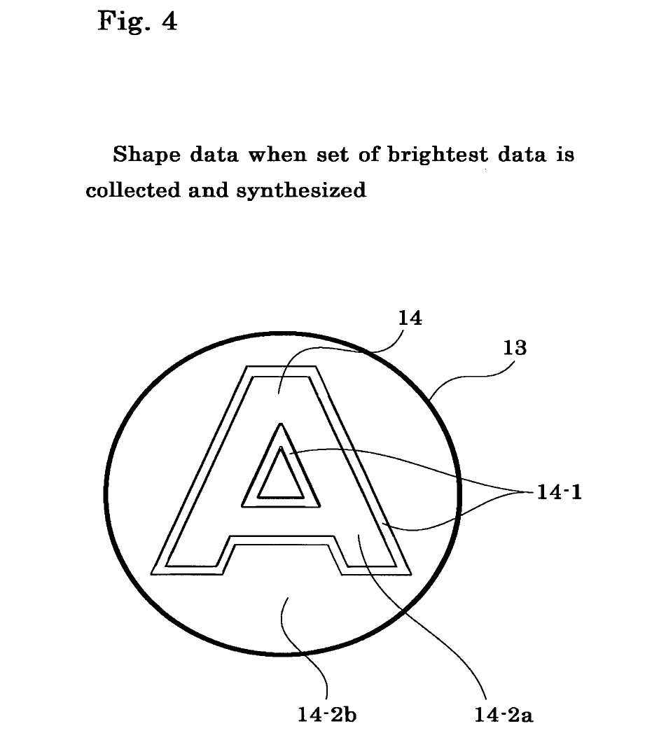

The light sources 15, 17, and 19 are constituted of a red LED 15, a green LED 17, and a blue LED 19, respectively emitting lights of wavelengths of substantially red, green, and blue colors, which are the three primary colors of light. The light sources 15, 17, and 19 are positioned apart from each other across a substantially equal interval along a circumference obliquely above the medal 13 surface. As shall be described below, positions in a height direction of the light sources 15, 17, and 19 with respect to the medal 13 are set appropriately in consideration of regionally dividing the medal 13 surface into a profile region 14-1, a top surface region 14-2a, and a bottom surface region 14-2b (see FIG. 4) in the incuse/relief portion 14. Light sources emitting the three primary colors of light having mutually different wavelengths are employed because, with the present invention aimed at performing authenticity judgment of high precision in a short time, it is preferable to capture an image upon illuminating light of the three colors simultaneously.

The optical filter 21 is disposed at a position opposing the medal 13 surface substantially straightly and has a function of separating lights having wavelengths of substantially red, substantially green, and substantially blue colors. By using the optical filter 21, the lights having the respective wavelengths of substantially red, substantially green, and substantially blue colors can be transmitted selectively. The image sensor 23 can thus acquire two-dimensional image data of respective brightness of R, G, and B separated via the optical filter 21.

The image sensor 23 is disposed at a position opposing the medal 13 surface substantially straightly and has functions of acquiring image data, including the incuse/relief portion 14 formed on the medal 13 surface, separately according to the respective wavelengths via the optical filter 21, and respectively outputting the acquired image data of the respective wavelengths.

The master data storage unit 25 has a function of storing, as the master data, image data expressing a shape of the incuse/relief portion 14 and corresponding, for example, to one or a combination of two or more shape data among shape data related to the profile region in the incuse/relief portion 14, shape data related to the top surface region, and shape data related to the bottom surface region as shall be described below.

The authenticity judging unit 27 includes: an image processing unit 33, successively applying such image processing as normalizing, multinarizing, image synthesizing, etc., on brightness information, including shading related to the incuse/relief portion 14, in the two-dimensional image data output from the image sensor 23; a correlation computing unit 35, determining a correlation of the image data, processed by the image processing unit 33 and including information expressing a shape of the incuse/relief portion 14 of the medal 13, and the master data; and an authenticity judging unit 37, performing authenticity judgment of the medal 13 based on a correlation result determined by the correlation computing unit 35.

The image processing unit 33 performs an image processing of using predetermined threshold values to multinarize the brightness information, including the shading related to the incuse/relief portion 14, in the two-dimensional image data acquired by the image sensor 23. Two or more of the predetermined threshold values are set in consideration that the medal 13 surface can be regionally divided into at least the profile region, the top surface region, and the bottom surface region in the incuse/relief portion 14, and the multinarization is performed by quantizing the brightness information, including the shading related to the incuse/relief portion 14, into three or more values using the two or more threshold values. The image processing unit 33 thus has a function of regionally dividing the medal 13 surface into the at least three regions by the image processing of multinarization into the three or more values.

The authenticity judging unit 27, arranged as described above, has functions of performing the image processing of subjecting the brightness information, including the shading related to the incuse/relief portion, in the respective image data obtained from the reflected lights having the respective wavelengths of substantially red, substantially green, and substantially blue, to the multinarization into three or more values using the two or more threshold values, regionally dividing the medal 13 surface into the at least three regions by the multinarization image processing, determining the correlation of the shape data of the incuse/relief portion 14, obtained by the image processing, and the master data, stored in the master data storage unit 25, and performing authenticity judgment of the medal 13 based on the determined correlation result.

### Basic Principles of the Coin Authenticity Judging Method According to the Embodiment of the Present Invention

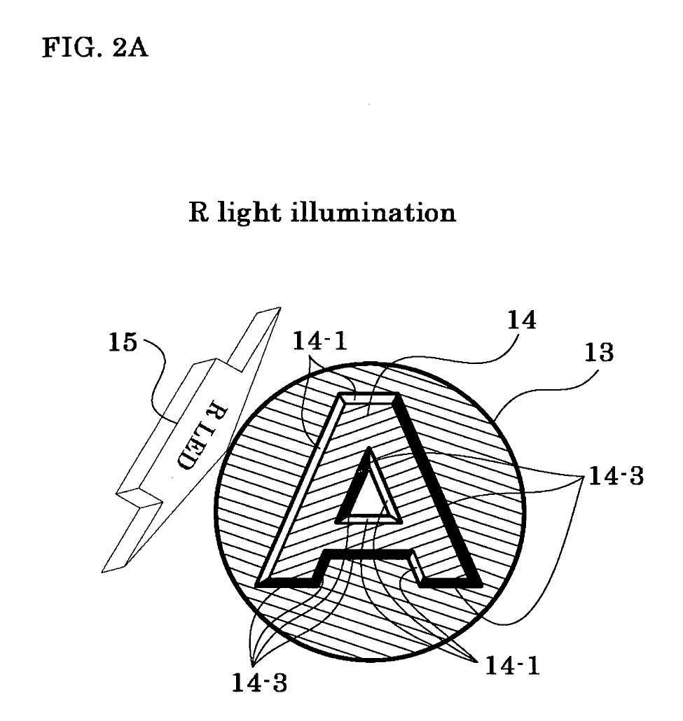

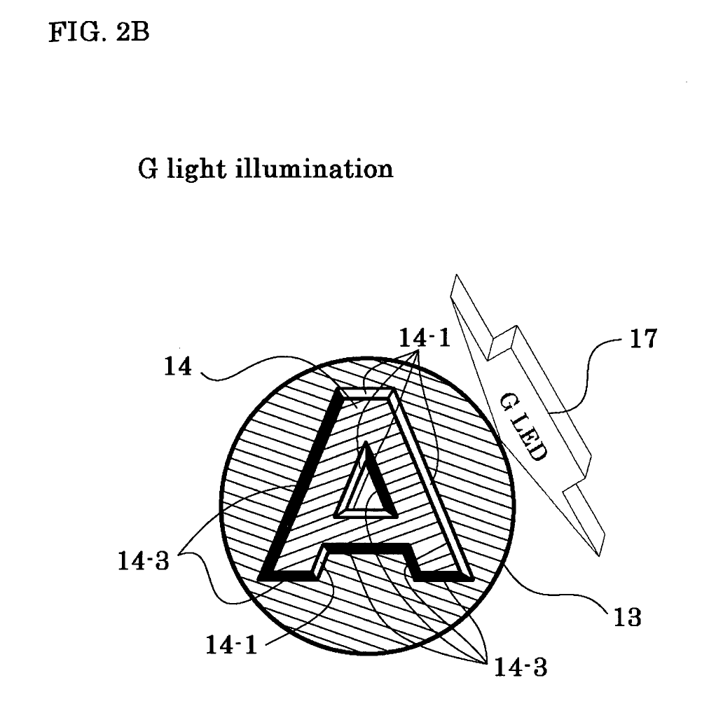

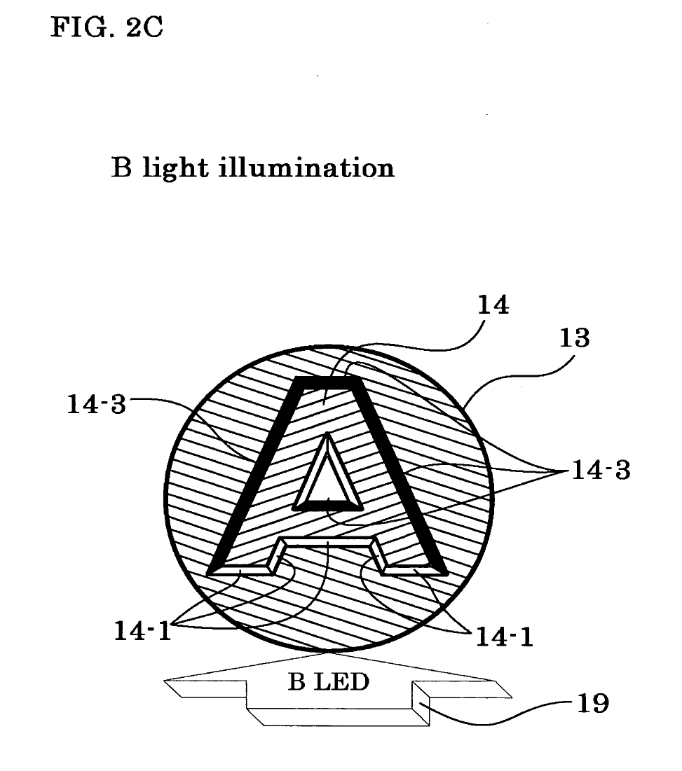

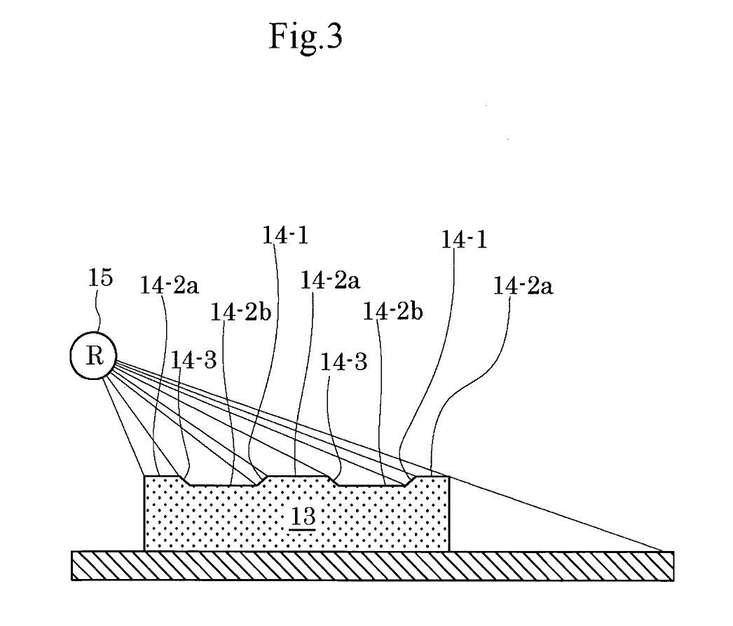

The basic principles of the coin authenticity judging method according to the embodiment of the present invention shall now be described with reference to FIGS. 2 and 3 for an example of illuminating LED light of the three colors of R, G, and B onto the medal 13 surface.

When as shown in each of FIGS. 2A, 2B, and 2C, light is illuminated onto the medal 13 surface from obliquely upward, the brightness of the incuse/relief portion 14, formed three-dimensionally on the medal 13 surface, and the periphery thereof differ significantly according to mutual actions of an incidence direction of the light and the incuse/relief portion 14.

As shown in FIG. 2A, by illumination of the R (red LED 15) light from a direction of 10:00 on a clock face, whereas the brightness of a light-source-side side surface 14-1, oriented toward the 10:00 direction in the incuse/relief portion 14, becomes bright, the brightness of a non-light-source-side side surface 14-3, oriented toward the opposite 16:00 direction, becomes dark.

Likewise, as shown in FIG. 2B, by illumination of the G (green LED 17) light from the direction of 14:00, whereas the brightness of a light-source-side side surface 14-1, oriented toward the 14:00 direction in the incuse/relief portion 14, becomes bright, the brightness of a non-light-source-side side surface 14-3, oriented toward the opposite side, becomes dark.

Likewise, as shown in FIG. 2C, whereas by illumination of the B (blue LED 19) light from the direction of 18:00, the brightness of a light-source-side side surface 14-1, oriented toward the 18:00 direction in the incuse/relief portion 14, becomes bright, the brightness at a non-light-source-side side surface 14-3, oriented toward the opposite 24:00 direction, becomes dark.

By proactively applying the occurrence of such significant brightness differences in the periphery of the incuse/relief portion 14, the incuse/relief portion 14, formed three-dimensionally on the medal surface 13, can be divided into the light-source-side side surface 14-1, which is the brightest, a general surface 14-2, which is intermediately bright, and the non-light-source-side side surface 14-3, which is the darkest and is disposed at the opposite side of the light source side, according to a classification related to the respective brightness as in the example of R (red LED 15) illumination shown in FIG. 3.

In order to perform such classification related to the respective brightness appropriately, the two threshold values used to perform multinarization or more specifically ternarization are set in consideration that, of the incuse/relief portion 14 formed on the medal surface 13, the side surface 14-1 at the light source side, the general surface 14-2, and the side surface 14-3 at the non-light-source side opposite the light source side can be divided according to the classification related to the respective brightness. To be more specific, the two threshold values are set in consideration that the surface region of the medal 13 can be divided into the three parts of the profile region 14-1 of the incuse/relief portion 14, the top surface region 14-2a of the incuse/relief portion 14, and the bottom surface region 14-2b of the incuse/relief portion 14. The two threshold values may be set for each of the R, G, and B colors or, as long as practical use is not hindered in regard to the classification according to the respective brightness, threshold values in common may be used for the respective colors.

After performing the classification according to the respective brightness, by extracting the brightest, light-source-side side surface 14-1 for each of R, G, B and synthesizing these (see FIG. 4), information, expressing a shape of the incuse/relief portion 14 in the medal 13, that is, in the present embodiment, information, expressing a profile shape of the incuse/relief portion 14, is formulated into data, and the process of judging the authenticity of the medal 13 is executed based on the shape data of the incuse/relief portion 14 thus obtained. Because in the present embodiment, the brightest, light-source-side side surface 14-1 refers to a rising side surface 14 of the incuse/relief portion in the medal 13, it can be understood that in a case where the incuse/relief portion 14 is a mark that is raised from the medal 13 surface, the isolated region 14-2a, surrounded from inside and outside by the side surface portion 14-1, is a top surface region, and the peripheral region 14-2b, spreading beyond a boundary region of the isolated region 14-2a and the side surface portion 14-1 is a bottom surface region in the incuse/relief portion 14.

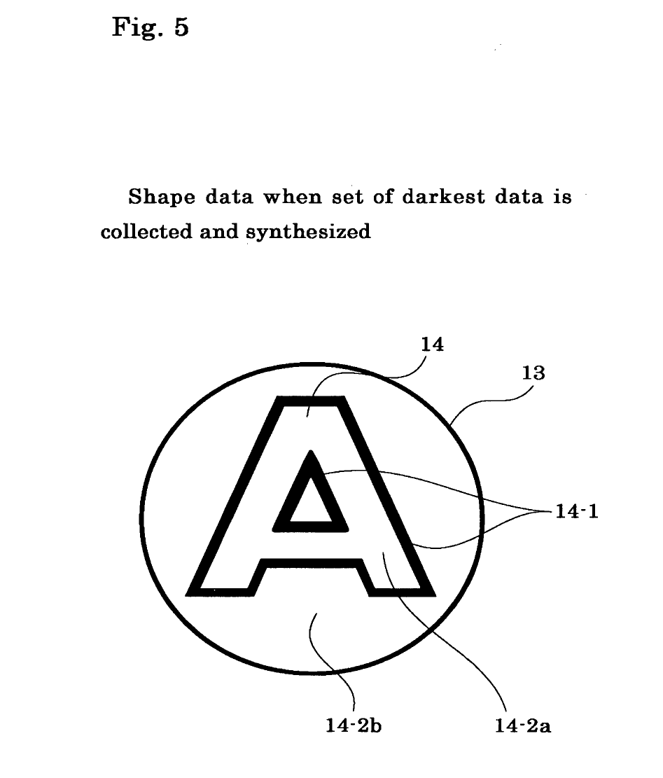

Also, by extracting the darkest, non-light-source-side side surface 14-3 for each of R, G, B and synthesizing these instead of the brightest light-source-side side surface 14-1 for each of R, G, B (see FIG. 5), information, expressing the shape of the incuse/relief portion 14 in the medal 13, that is, in the present embodiment, information, expressing the profile shape of the incuse/relief portion 14, is formulated into data, and the process of judging the authenticity of the medal 13 is executed based on the shape data of the incuse/relief portion 14 thus obtained. Because, as with the above-described example of the brightest, light-source-side side surface 14-1, in the present embodiment, the darkest, non-light-source-side side surface 14-3 refers to a rising side surface of the incuse/relief portion 14 in the medal 13, it can be understood that the isolated region 14-2a, surrounded from inside and outside by the side surface portion 14-3, is the top surface region, and the peripheral region 14-2b, spreading beyond the boundary region of the isolated region 14-2a and the side surface portion 14-3 is the bottom surface region in the incuse/relief portion 14.

### Coin Authenticity Judging Method According to the Embodiment of the Present Invention

To describe the coin authenticity judging method according to the embodiment of the present invention in outline based on the basic principles described above, a spirit of the coin authenticity judging method is that image data of the incuse/relief portion 14, formed on the medal 13 surface, are acquired by capturing an image of the incuse/relief portion 14 by means of the image sensor (imaging unit) 23, disposed so as to oppose the medal 13 substantially straightly, while illuminating light from the light source disposed obliquely above the medal 13, the image processing of using the predetermined threshold values to multinarize the brightness information, including the shading related to the incuse/relief portion 14, in the acquired image data is performed, and the authenticity of the medal 13 is judged based on the shape data of the incuse/relief portion 14 obtained by the image processing and the master data, including the shape of the incuse/relief portion 14 formed on the surface of the authentic medal 13, and as the predetermined threshold values, two or more threshold values are set in consideration that the medal 13 surface can be regionally divided into at least the profile region 14-1, the top surface region 14-2a, and the bottom surface region 14-2b in the incuse/relief portion 14, the multinarization is performed by using the two or more threshold values to quantize the brightness information, including the shading related to the incuse/relief portion 14, into three or more values, and by the image processing of multinarization into the three or more values, the medal 13 surface is regionally divided at least into the three regions.

With the present coin authenticity judging method, the image data of the incuse/relief portion 14, formed on the medal 13 surface, are acquired by capturing the image of the incuse/relief portion 14 by means of the image sensor 23, disposed so as to oppose the medal 13 substantially straightly, while illuminating light from the light source disposed obliquely above the medal 13, and the image processing of using the predetermined threshold values to multinarize the brightness information, including the shading related to the incuse/relief portion 14, in the acquired image data is performed. In the image processing, as the predetermined threshold values, two or more threshold values are set in consideration that the medal 13 surface can be divided into at least the profile region 14-1, the top surface region 14-2a, and the bottom surface region 14-2b in the incuse/relief portion 14, the multinarization is performed by using the two or more threshold values to quantize the brightness information, including the shading related to the incuse/relief portion 14, into three or more values, and by the image processing of multinarization into the three or more values, the medal 13 surface is regionally divided at least into the three regions. The authenticity of the medal 13 is then judged based on the shape data of the incuse/relief portion 14 obtained by the image processing and the master data, including the shape of the incuse/relief portion formed on the surface of the authentic medal 13. Thus as a result of enabling the authenticity of the medal 13 to be judged based on the shape data of the incuse/relief portion 14, identified at high precision by the medal 13 surface being regionally divided into the at least three regions, the precision of authenticity judgment of the medal 13 can be improved significantly.

### Operation of the Coin Authenticity Judging Device According to the Embodiment of the Present Invention

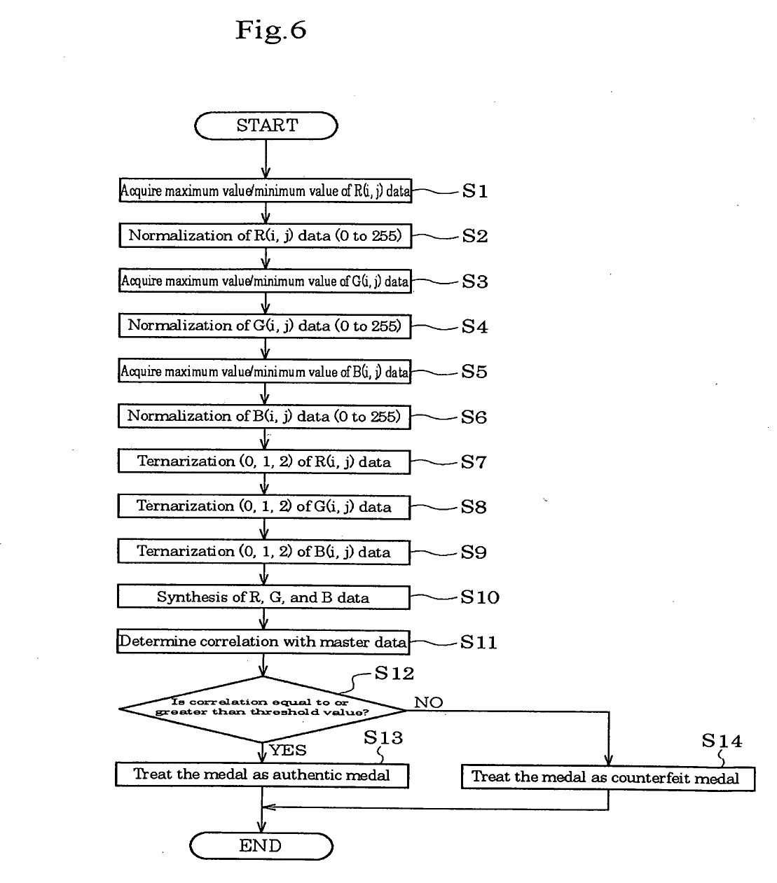

Operation of the coin authenticity judging device according to the embodiment of the present invention shall now be described with reference to FIG. 6, using an example of authenticity judgment based on the shape data of the incuse/relief portion 14 in the medal 13.

In steps S1 and S2, the image processing unit 33 performs a process of performing a predetermined computation on two-dimensional image data R(i, j), corresponding to the reflected light due to the R (red LED 15) light illumination, to acquire a minimum value and a maximum value of an image level corresponding to brightness and performing a computation, in which an absolute value of a difference between the minimum value and the maximum value is handled as a denominator and an absolute value of a difference between each successively acquired two-dimensional image data R(i, j) value and the minimum value is handled as a numerator, to normalize the successively acquired two-dimensional image data R(i, j) according to a 256-value gray scale or other suitably changeable gray scale (the same applies hereinafter).

Likewise, in steps S3 and S4, the image processing unit 33 performs the process of performing the predetermined computation on two-dimensional image data G(i, j), corresponding to the reflected light due to the G (green LED 17) light illumination, to acquire the minimum value and the maximum value of the image level corresponding to brightness and performing the computation, in which the absolute value of the difference between the minimum value and the maximum value is handled as the denominator and the absolute value of the difference between each successively acquired two-dimensional image data G (i, j) value and the minimum value is handled as the numerator, to normalize the successively acquired two-dimensional image data G(i, j) according to the 256-value gray scale.

Likewise, in steps S5 and S6, the image processing unit 33 performs the process of performing the predetermined computation on two-dimensional image data B(i, j), corresponding to the reflected light due to the B (blue LED 19) light illumination, to acquire the minimum value and the maximum value of the image level corresponding to brightness and performing the computation, in which the absolute value of the difference between the minimum value and the maximum value is handled as the denominator and the absolute value of the difference between each successively acquired two-dimensional image data B (i, j) value and the minimum value is handled as the numerator, to normalize the successively acquired two-dimensional image data G(i, j) according to the 256-value gray scale.

Then in step S7, the image processing unit 33 performs a ternarization process on the two-dimensional image data R(i, j) by performing a predetermined computation based on the respective normalized two-dimensional image data R(i, j), related to the reflected light due to the R (red LED 15) light illumination, and the two threshold values. Here, as the two threshold values, those set in consideration that the surface region of the medal 13 can be divided into the three regions of the profile region 14-1 of the incuse/relief portion 14, the top surface region 14-2a of the incuse/relief portion 14, and the bottom surface region 14-2b of the incuse/relief portion 14 are employed (the same applies hereinafter).

Likewise in step S8, the image processing unit 33 performs the ternarization process on the two-dimensional image data G(i, j) by performing the predetermined computation based on the respective normalized two-dimensional image data G(i, j), related to the reflected light due to the G (green LED 17) light illumination, and the two threshold values.

Likewise in step S9, the image processing unit 33 performs the ternarization process on the two-dimensional image data B(i, j) by performing the predetermined computation based on the respective normalized two-dimensional image data B(i, j), related to the reflected light due to the B (blue LED 19) light illumination, and the two threshold values.

Next in step S10, the image processing unit 33 performs a process of collecting and synthesizing a set of data, among the ternarized two-dimensional image data obtained for each of the colors, R, G, and B, to which is allocated the value belonging to a brightest set (for example, this value corresponds to being “2” when quantization is performed by allocating “0,” “1,” and “2,” in an order from dark to bright), that is, collecting and synthesizing the data of the light-source-side side surface 14-1 as shown in FIG. 4 to formulate the shape (profile) of the incuse/relief portion 14 in the medal 13 into data. In place of or in addition to collecting and synthesizing the set of data to which the value belonging to the brightest set is allocated, a process of collecting and synthesizing a set of data to which is allocated the value belonging to a darkest set (for example, this value corresponds to being “0” when quantization is performed by allocating “0,” “1,” and “2,” in the order from dark to bright), that is, collecting and synthesizing the data of the non-light-source-side side surface 14-3 as shown in FIG. 5 to formulate the shape (profile) of the incuse/relief portion 14 in the medal 13 into data may be performed. Here, a process, of collecting and synthesizing the set of brightest data, collecting and synthesizing the set of darkest data, comparing and collating the two, and formulating the shape (profile) of the incuse/relief portion 14 of the medal 13 into data based on the synthesized data when the synthesized data are found to be matched by the comparison and collation, may be executed. By this arrangement, as a result of being able to ascertain the shape of the incuse/relief portion 14 in the medal 13 at high precision, further improvement of the authenticity judgment precision can be realized.

In step S11, the correlation computing unit 35 executes a correlation computation process of determining a correlation value of the data expressing the shape of the incuse/relief portion 14 obtained in step S10 and the master data and performing a magnitude comparison of the correlation value thus determined and a threshold value, set in advance for determining correlation or non-correlation. Whereas when, by the correlation computation process, the correlation value is found to be no less than the threshold value, the correlation computation unit 35 deems that the medal subject to examination is authentic and directs the process flow to entering step S13, when the correlation value is found to be less than the threshold value, the medal subject to examination is deemed to be counterfeit and the process flow is directed to enter step S14.

The authenticity judgment result that is thus obtained is displayed on the display unit 29 and the authenticity judgment result of the medal subject to examination is thereby notified to a user.

### EFFECT(S) OF THE EMBODIMENT

As described in detail above, with the coin authenticity judging method according to the embodiment of the present invention, the image data of the incuse/relief portion 14, formed on the medal 13 surface, are acquired by capturing the image of the incuse/relief portion 14 by means of the image sensor 23, disposed so as to oppose the medal 13 substantially straightly, while illuminating light from the light source disposed obliquely above the medal 13, and the image processing of using the predetermined threshold values to multinarize the brightness information, including the shading related to the incuse/relief portion 14, in the acquired image data is performed. In the image processing, the two or more threshold values, set as the predetermined threshold values in consideration that the medal 13 surface can be regionally divided into at least the profile region 14-1, the top surface region 14-2a, and the bottom surface region 14-2b in the incuse/relief portion 14, are employed, the multinarization is performed by using the two or more threshold values to quantize the brightness information, including the shading related to the incuse/relief portion 14, into three or more values, and by the image processing of multinarization into the three or more values, the medal 13 surface is regionally divided at least into the three regions. The authenticity of the medal 13 is then judged based on the shape data of the incuse/relief portion 14 obtained by the image processing and the master data, including the shape of the incuse/relief portion formed on the surface of the authentic medal 13. Thus as a result of enabling the authenticity of the medal 13 to be judged based on the shape data of the incuse/relief portion 14, identified at high precision by the medal 13 surface being regionally divided into the at least three regions, the authenticity judgment precision of the medal 13 can be improved significantly.

Also because, as the light source for illuminating light onto the medal 13, three light sources of mutually different wavelengths, specifically, the light sources of substantially red, substantially green, and substantially blue wavelengths are employed and these are positioned apart from each other across a substantially equal interval, because, as the optical filter, the filter that separates the lights having substantially red, substantially green, and substantially blue wavelengths respectively is employed, because, of the image data according to each wavelength, the set of data belonging to the predetermined brightness, for example, the set of the brightest data or the set of the darkest data are synthesized, and because the authenticity judgment of the medal 13 is performed by determining the correlation of the shape data of the incuse/relief portion 14 obtained by the synthesis and the master data, the shape of the incuse/relief portion 14 in the medal 13 can be ascertained at high precision while performing authenticity judgment allowing for some degree of fuzziness (in consideration of abrasion of the medal 13 with time) by employing the concept of correlation/non-correlation and consequently, a realistic authenticity judgment can be realized while maintaining high precision of the authenticity judgment of the medal 13.

Meanwhile, with the coin authenticity judging device 11 according to the embodiment of the present invention, the authenticity judging unit 27 performs the image processing using the predetermined threshold values to multinarize the brightness information, including the shading related to the incuse/relief portion 14, in the image data acquired by image capture by the image sensor 23. In the image processing, the two or more threshold values, set as the predetermined threshold values in consideration that the medal 13 surface can be regionally divided at least into the profile region 14-1, the top surface region 14-2a, and the bottom surface region 14-2b in the incuse/relief portion 14, are employed, the multinarization is performed by using the two or more threshold values to quantize the brightness information, including the shading related to the incuse/relief portion 14, into three or more values, and by the image processing of multinarization into the three or more values, the medal 13 surface is regionally divided into at least the three regions. The authenticity judging unit 27 then judges the authenticity of the medal 13 based on the shape data of the incuse/relief portion 14 obtained by the image processing and the master data, including the shape of the incuse/relief portion 14 formed on the surface of the authentic medal 13. As a result of enabling the authenticity of the medal 13 to be judged based on the shape data of the incuse/relief portion 14, identified at high precision by the medal 13 surface being regionally divided into the at least three regions, the coin authenticity judging device, enabling the authenticity judgment precision of the medal 13 to be improved significantly, can be provided.

Also because, as the light source for illuminating light onto the medal 13, the three light sources of mutually different wavelengths, specifically, light sources of substantially red, substantially green, and substantially blue wavelengths are employed and these are positioned apart from each other across a substantially equal interval, because, as the optical filter, the filter that separates the lights having substantially red, substantially green, and substantially blue wavelengths respectively is employed, because, of the image data according to each wavelength, the set of data belonging to the predetermined brightness, for example, the set of the brightest data or the set of the darkest data are synthesized, and because the authenticity judgment of the medal 13 is performed by determining the correlation of the shape data of the incuse/relief portion 14 obtained by the synthesis and the master data, the shape of the incuse/relief portion 14 in the medal 13 can be ascertained at high precision while performing authenticity judgment allowing for some degree of fuzziness (in consideration of abrasion of the medal 13 with time) by employing the concept of correlation/non-correlation and consequently, the coin authenticity judging device, enabling realization of a realistic authenticity judgment while maintaining high precision of the authenticity judgment of the medal 13, can be provided.

In a case where such an authenticity judging process is applied to a medal or coin, used as a game medium in a game center or other amusement facility, if, for example, a medal from another store is brought into a certain store, an authenticity judgment of deeming the other store's medal to be counterfeit (in other words, is not a medal of the certain store) can be made appropriately, and as a result of thus being able to eliminate medals of other stores, a problem in terms of management of a total number of medals in cases where medals of other stores become mixed with the medals of the certain store can be resolved.

### DISCLOSURE OF MODIFICATION EXAMPLE(S)

The present invention is not restricted to the above-described embodiment and can be changed suitably within a scope that does not fall outside the gist or philosophy of the art of the present invention that can be inferred from the claims and the entire specification, and a coin authenticity judging method and a coin authenticity judging device that accompanies such changes are included within the scope of the art of the present invention.

That is, for example, although with the embodiment, an example of application of the present invention to authenticity judgment of a medal used as a game medium in a game center or other amusement facility was described, the present invention is not restricted to this example, and the present invention can be applied as it is to currency and tokens.

Also although with the embodiment, an example of employing LEDs of the three colors of R, G, and B (substantially red, substantially green, and substantially blue) as the plurality of light sources with mutually different wavelengths was described, the present invention is not restricted to this example, and light sources of any wavelength may be used in combination as long as images can be captured in a distinguishing manner according to the different wavelengths at the imaging unit.

Furthermore, although with the embodiment, a mode of storing the image data including the incuse/relief portion 14 formed on the surface of the authentic medal was described as an example of the function of the master data storage unit 25, in regard to details of this mode, raw image data, resulting from capturing the image of the authentic medal, may be employed, compressed image data, obtained by applying image processing to the raw image data, may be employed, or as in the embodiment, ternarized image data may be employed. In the case where the ternarized image data are employed as the master data, a memory storage capacity for the master data can be reduced in comparison to the case where the raw image data are used as the master data.

Lastly, a coin surface in the present invention is obviously a concept that includes one surface, the other surface, and a side surface of a coin.

What is claimed is:

1. A coin authenticity judging method comprising the steps of:
acquiring image data of an incuse/relief portion, formed on a surface of a coin, by illuminating light from a light source, disposed obliquely above the coin, and meanwhile capturing an image of the incuse/relief portion by an imaging unit, disposed so as to oppose the coin substantially straightly;
performing an image processing of using predetermined threshold values to multinarize brightness information, including shading related to the incuse/relief portion, in the acquired image data; and
judging authenticity of the coin based on shape data of the incuse/relief portion, obtained by the image processing, and master data, including a shape of an incuse/relief portion formed on a surface of an authentic coin; and
wherein, as the predetermined threshold values,
two or more threshold values are set in consideration that the surface of the coin can be regionally divided into at least a profile region, a top surface region, and a bottom surface region in the incuse/relief portion,
the multinarization is performed by quantizing the brightness information, including the shading related to the incuse/relief portion, into three or more values using the two or more threshold values, and
the surface of the coin is regionally divided into at least the three regions by the image processing of multinarization into the three or more values.

2. The coin authenticity judging method according to claim 1, wherein
the image data of the incuse/relief portion are acquired by illuminating a plurality of lights, having mutually different wavelengths, from a plurality of light sources, disposed obliquely above the coin, and meanwhile capturing an image of the incuse/relief portion by the imaging unit through an optical filter that separates reflected light from the incuse/relief portion according to respective wavelengths, and
the authenticity judgment of the coin is performed by collecting and synthesizing, from among the image data of the respective wavelengths that have been subject to the multinarization image processing, a set of data belonging to a predetermined brightness and determining, based on shape data of the incuse/relief portion, obtained by the synthesis, and the master data, a correlation between the shape data and the master data.

3. The coin authenticity judging method according to claim 2, wherein
the predetermined brightness is both or either of a set of brightest data and a set of darkest data among the image data of the respective wavelengths that have been subject to the multinarization image processing.

4. The coin authenticity judging method according to claim 2, wherein
the plurality of light sources are three light sources, with mutually different wavelengths, and the light sources are positioned apart from each other across a substantially equal interval.

5. The coin authenticity judging method according to claim 4, wherein
the three light sources have wavelengths of a substantially red color, a substantially green color, and a substantially blue color, and the optical filter separates lights having wavelengths of a substantially red color, a substantially green color, and a substantially blue color.

6. A coin authenticity judging device comprising:
a light source, disposed obliquely above a coin and illuminating light toward the coin;
an imaging unit, disposed so as to oppose the coin substantially straightly and capturing an image and thereby acquiring image data of an incuse/relief portion formed on a surface of the coin;
a master data storage unit, storing master data, including a shape of an incuse/relief portion formed on a surface of an authentic coin;
an image processing unit, performing an image processing of using predetermined threshold values to multinarize brightness information, including shading related to the incuse/relief portion, in the image data acquired by the imaging unit; and
an authenticity judging unit, judging authenticity of the coin based on shape data of the incuse/relief portion, obtained by the image processing unit, and the master data, stored in the master data storage unit; and
wherein, as the predetermined threshold values,
two or more threshold values are set in consideration that the surface of the coin can be regionally divided at least into a profile region, a top surface region, and a bottom surface region in the incuse/relief portion,
the multinarization is performed by quantizing the brightness information, including the shading related to the incuse/relief portion, into three or more values using the two or more threshold values, and
the image processing unit regionally divides the surface of the coin into at least the three regions by the image processing of multinarization into the three or more values.

7. The coin authenticity judging device according to claim 6, wherein
the light source is a plurality of light sources, illuminating a plurality of lights, having mutually different wavelengths, onto the coin,
the imaging unit captures the image of and thereby acquires the incuse/relief portion through an optical filter that separates reflected light from the incuse/relief portion according to respective wavelengths,
the image processing unit has a function of collecting and synthesizing, from among the image data of the respective wavelengths that have been subject to the multinarization image processing, a set of data belonging to a predetermined brightness and
furthermore comprises a correlation computing unit, determining, based on shape data of the incuse/relief portion, obtained by the synthesis, and the master data, a correlation between the shape data and the master data, and
the authenticity judging unit judges the authenticity of the coin based on a computation result of the correlation computing unit.

8. The coin authenticity judging device according to claim 7, wherein
the predetermined brightness is both or either of a set of brightest data and a set of darkest data among the image data of the respective wavelengths that have been subject to the multinarization image processing.

9. The coin authenticity judging device according to claim 7, wherein
the plurality of light sources are three light sources, with mutually different wavelengths, and the light sources are positioned apart from each other across a substantially equal interval.

10. The coin authenticity judging device according to claim 9, wherein
the three light sources have wavelengths of a substantially red color, a substantially green color, and a substantially blue color, and the optical filter separates lights having wavelengths of a substantially red color, a substantially green color, and a substantially blue color.
